(19) United States
(12) Patent Application Publication
(10) Pub. No.: US 2005/0020285 A1
(43) Pub. Date: Jan. 27, 2005

(54) Mobile communication terminal

(75) Inventors: Katsuhiro Kozuki, Tokyo (JP); Takeshi Sakuma, Tokyo (JP)

Correspondence Address: BANNER & WITCOFF, 1001 G STREET N W, SUITE 1100, WASHINGTON, DC, 20001, US

(73) Assignees: KDDI Corporation, Shinjuku-ku (JP); Kabushiki Kaisha Toshiba, Minato-ku (JP)

(21) Appl. No.: 10/854,790

(22) Filed: May 27, 2004

Related U.S. Application Data
(63) Continuation of application No. PCT/JP02/11368, filed on Oct. 31, 2002.

(30) Foreign Application Priority Data
Nov. 30, 2001 (JP) 2001-367853

(51) Int. Cl. H04N 7/06

(52) U.S. Cl. 455/456.6

(57) ABSTRACT

A CDMA mobile communication terminal MS receives system time data, as standard time information, the system time data being transmitted from a base station BS via a sync-channel. When reproducing contents, a reproduction expiration time contained in the contents is compared with the received standard time information, thereby detecting whether or not the contents can be reproduced. If it is detected that the contents may be reproduced, reproduction of the contents is permitted, whereas if it is detected that the contents should not be reproduced, reproduction of the contents is inhibited.

### CROSS-REFERENCE TO RELATED APPLICATIONS

This is a Continuation Application of PCT Application No. PCT/JP02/11368, filed Oct. 31, 2002, which was not published under PCT Article 21(2) in English.

This application is based upon and claims the benefit of priority from prior Japanese Patent Application No. 2001-367853, filed Nov. 30, 2001, the entire contents of which are incorporated herein by reference.

### 1. FIELD OF THE INVENTION

The present invention relates to a mobile communication terminal such as a mobile phone, and more particularly to a device having a function for reproducing contents on or before a set expiration time.

### 2. DESCRIPTION OF THE RELATED ART

In the field of mobile communication terminals, such as mobile phones, portable data terminals (e.g. PDAs: Personal Digital Assistances), etc., devices have been developed which have a function for reproducing contents received via a communication network or recorded on a recording medium. These devices are very convenient since they enable users to enjoy contents, such as favorite music or video, anywhere.

In the meantime, contents in which a reproduction valid term (e.g. reproduction is valid for only three days after downloading) or reproduction expiration time (e.g. reproduction is valid until 30 Nov. 2001) is set for the protection of copyright, are now increasing. When such contents are reproduced, in conventional mobile communication terminals, the reproduction valid term or reproduction expiration time set for the contents is compared with the present time of an internal clock. If the present time is within the reproduction valid term or on or before the reproduction expiration time, the contents are reproduced.

However, in general, internal clocks employed in mobile communication terminals have errors caused by reference oscillators. Accordingly, when the errors are large, the reproduction term of contents cannot be accurately managed. Further, the time of the internal clocks of such devices can be manually adjusted. Therefore, if a user intentionally changes the time of the internal clock, contents remain reproduceable even after their expiration time, which makes it impossible to prevent unauthorized use of the contents.

### BRIEF SUMMARY OF THE INVENTION

The present invention has been developed in light of the above-described circumstances, and aims to provide a mobile communication terminal capable of accurately managing a reproduction expiration time regardless of errors in the internal clock, thus effectively preventing unauthorized use of contents.

To satisfy the aim, there is provided a mobile communication terminal including a function for reproduction of contents that contain a reproduction expiration time. In this terminal, standard time acquisition means for acquiring a standard time from an external device is provided. The standard time acquired by the acquisition means is compared with the reproduction expiration time of the contents by comparing means, detecting means detecting whether or not the standard time has exceeded the reproduction expiration time of the contents. If it is detected that the standard time has not exceeded the reproduction expiration time of the contents, reproduction of the contents is permitted by reproduction control means.

In other words, to satisfy the aim, there is provided a mobile communication terminal including a function for reproduction of contents that contain a reproduction expiration time. In this terminal, means for acquiring a standard time from an external device is provided. The standard time acquired by the acquiring means is compared with the reproduction expiration time of the contents by a comparator, a detector detecting whether or not the standard time has exceeded the reproduction expiration time of the contents. If it is detected that the standard time has not exceeded the reproduction expiration time of the contents, reproduction of the contents is permitted by a reproduction controller.

Thus, in the invention, detection as to the reproduction expiration time of contents is always executed with reference to the standard time, irrespective of the time measured by an internal clock. This can avoid the influence of an error in the internal clock, the invention realizing accurate detection as to the reproduction expiration time. It can also avoid the influence of a user's intentional change of the measured time, the invention preventing unauthorized use of contents.

For example, the standard time acquisition means may be constructed in the following manners.

Firstly, if the mobile communication terminal has a radio communication function used to connect the mobile communication terminal to a base station for a mobile communication system which employs a CDMA (Code Division Multiple Access) system, the standard time acquisition means receives system time data transmitted from the base station via a control channel, using the radio communication function.

This structure enables the standard time to be acquired by a known device that has no new receiving function dedicated to the acquisition of the standard time.

Secondly, if the mobile communication terminal has a GPS (Global Positioning System) receiving function, the standard time acquisition means receives system time data transmitted from a GPS satellite, using the GPS receiving function.

This structure enables the terminal to acquire the standard time by receiving a GPS signal, even when it is situated in a place in which the signals transmitted from the base station for the mobile communication system cannot be received. In other words, the structure enables the terminal to be used anywhere.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the preferred embodiments given below, serve to explain the principles of the invention.

FIG. 1 is a block diagram illustrating the configuration of a CDMA mobile communication terminal according to an embodiment of the invention; and

FIG. 2 is a flowchart illustrating the procedure of contents reproduction control executed by the controller of the CDMA mobile communication terminal shown in FIG. 1.

### DETAILED DESCRIPTION OF THE INVENTION

A CDMA (Code Division Multiple Access) mobile communication terminal, according to an embodiment of the invention, receives system time data that is sent from a base station via control channel and serves as standard time data, and compares, when reproducing contents, the reproduction invalid term contained in the contents, with the standard time data, thereby detecting whether or not the contents can be reproduced. If it is detected that they maybe reproduced, the contents are permitted to be reproduced, whereas if it is detected that they should not be reproduced, the reproduction of the contents is inhibited.

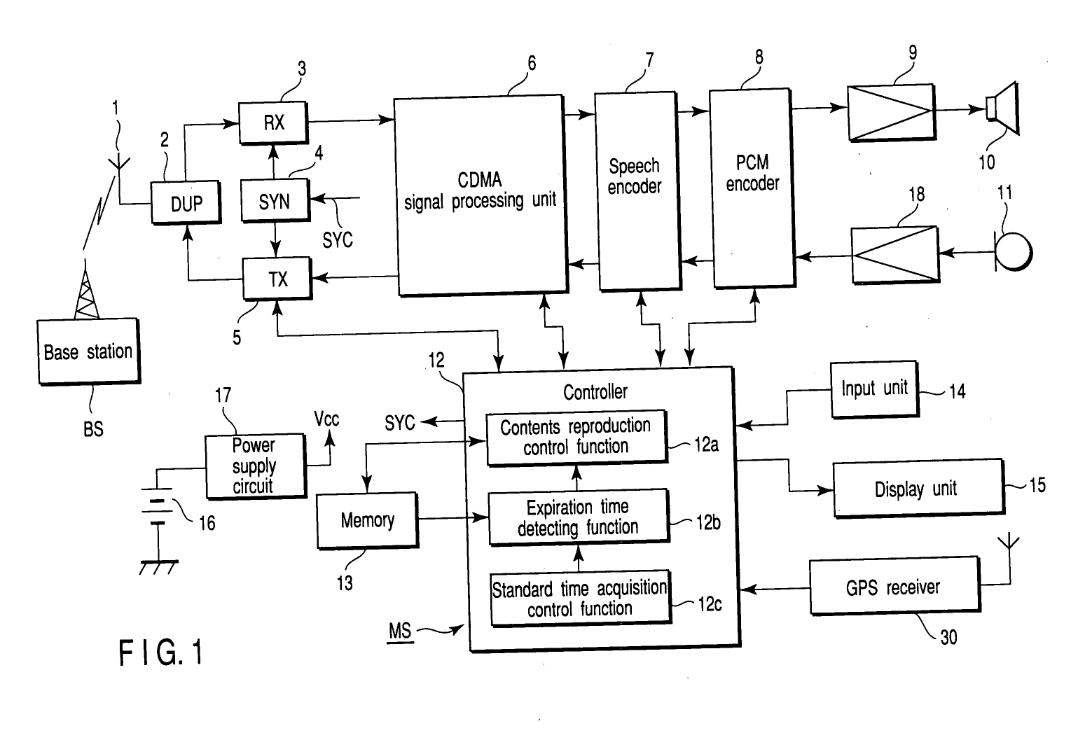

FIG. 1 is a block diagram illustrating the configuration of the CDMA mobile communication terminal according to the embodiment of the invention. The mobile communication terminal MS employs the CDMA (Code Division Multiple Access) system as a radio communication system between itself and a base station BS.

A radio frequency signal transmitted from the base station BS is first received by an antenna 1, and is then input to a receiving circuit (RX) 3 via an antenna duplexer (DUP) 2. The receiving circuit 3 mixes the radio frequency signal with a receiving local oscillation signal output from a frequency synthesizer (SYN) 4, thereby frequency-converting the signal into an intermediate frequency signal or baseband signal. The frequency of the receiving local oscillation signal generated from the frequency synthesizer 4 is designated by a control signal SYC from a controller 12.

The receiving intermediate frequency signal or receiving baseband signal is input to a CDMA signal processing unit 6. The CDMA signal processing unit 6 executes orthogonal demodulation processing, and despreading processing using a spreading code assigned to the receiving channel, on the receiving intermediate frequency signal or receiving baseband signal, thereby obtaining demodulated data of a predetermined format corresponding to the data rate. The demodulated data is input to a speech encoder 7. The control data contained in the demodulated data, the control data indicating the data rate, is input, as receiving data rate, to the controller 12.

The speech encoder 7 executes expansion processing corresponding to the receiving data rate reported from the controller 12, on the demodulated data output from the CDMA signal processing unit 6, and then executes decoding processing using, for example, Viterbi decoding, and error-correction decoding processing, thereby reproducing a received digital data of a baseband.

A PCM encoder 8 executes different signal processes between different types of communication output from the controller 12 (speech or data communication). Specifically, when speech communication is executed, the receiving digital data output from speech encoder 7 is PCM-decoded, thereby outputting an analog receiving signal. This analog receiving signal is amplified by a receiving signal amplifier 9 and output as a speech from a speaker 10. During data communication, the receiving digital data output from the speech encoder 7 is sent to the controller 12. The controller 12 stores the receiving digital data in a memory 13 and displays it on a display unit 15.

When necessary, the receiving digital data can be transferred, via an external interface (not shown), to an external information terminal, such as a portable data terminal (e.g. PDA: Personal Digital Assistant), a notebook personal computer, etc., which are not shown.

On the other hand, the input voice of a speaker during speech communication is input as an analog speech signal via a microphone 11, and is amplified to an appropriate level by a speech amplifier 18. After that, the analog speech signal amplified is input to the PCM encoder 8. The PCM encoder 8 executes PCM encoding on the input analog speech signal. The resultant transmission data is supplied to the speech encoder 7. Further, the data output from the external information terminal is input to the controller 12 via an external interface (not shown), then input to the speech encoder 7 via the PCM encoder 8 from the controller 12.

During speech communication, the speech encoder 7 detects the energy of input voice on the basis of the transmission audio data output from the PCM encoder 8, and detects the data rate from the detection result. After that, the transmission data is compressed into a burst signal of a format corresponding to the determined data rate, then subjected to error-correction coding, and output to the CDMA signal processing unit 6. On the other hand, during data communication, the transmission data output from the PCM encoder 8 is compressed into a burst signal of a format corresponding to a preset data rate. After that, the compressed transmission data is subjected to error-correction coding and output to the CDMA signal processing unit 6. The data rate during speech and data communication is reported, as a transmission data rate, to the controller 12.

The CDMA signal processing unit 6 executes spread processing on the burst signal compressed by the speech encoder 7, using a spreading code assigned to the transmission channel used. Thereafter, the unit 6 executes orthogonal modulation on the transmission signal obtained by spread coding, and outputs the resultant orthogonal modulation signal to a transmission circuit (TX) 5.

The transmission circuit 5 synthesizes, into a radio frequency signal, the orthogonal modulation signal output from the CDMA signal processing unit 6, and a transmission local oscillation signal output from the frequency synthesizer 4. After that, the transmission circuit 5 amplifies the higher frequency components of only the effective portion of the radio frequency signal on the basis of the transmission data rate reported by the controller 12, and outputs the resultant signal as a transmission radio frequency signal. The transmission radio frequency signal output from the transmission circuit 5 is supplied to the antenna 1 via the antenna duplexer 2, and transmitted as burst transmission from the antenna 1 to a base station (not shown).

An input unit 14 is provided with a key group that includes dial keys, a call origination key, power key, end key, volume key and mode designation key, etc. The display unit 15 is provided with an LCD display and an LED. The LCD display displays information stored in a telephone book, the history of outgoing calls and/or incoming calls, the phone number of a caller or a person called, mail addresses, the operation state of the terminal, etc. Further, the LED is lightened or flickered to inform a user of a coming call, or to require the charge of a battery 16.

Reference numeral 17 denotes a power supply circuit, which generates a predetermined operation power voltage Vcc based on the output of the battery 16, and supplies the Vcc to each circuit unit. Further, the power supply circuit 17 contains a charging circuit for charging the battery 16.

The controller 12 is formed of, for example, a microcomputer as a main controller, and has standard control functions for mobile terminals, such as a communication control function for executing radio connection control in response to an outgoing call or an incoming call, thereby enabling speech or data communication, a position registration control function, an idle hand-off control function, etc. The controller also has new control functions according to the embodiment of the invention, such as a contents reproduction control function 12a, an expiration time detecting function 12b, and a standard time acquisition control function 12c.

The standard time acquisition control function 12c is used, before the reproduction of contents, to switch the receiving channel from a paging channel used in an idle state, to a sync-channel, thereby receiving a sync-channel signal. The base station BS inserts system time data into the sync-channel signal, and transmits the resultant signal. The standard time acquisition control function 12c extracts the system time data from the received sync-channel signal, and uses the system time data as standard time data.

The expiration time detecting function 12b compares the standard time data extracted by the standard time data acquisition control function 12c, with a reproduction expiration time, if this reproduction expiration time is contained in the above-mentioned contents, thereby detecting whether or not the standard time has exceeded the expiration time.

The contents reproduction control function 12a reads the contents from the memory 13 and executes control for their reproduction, if the expiration time detecting function 12b detects that the standard time is one or before the expiration time. On the other hand, if it is detected that the standard time is after the expiration time, reproduction of the contents is inhibited.

Each of the contents reproduction control function 12a, expiration time detecting function 12b, and standard time acquisition control function 12c is realized by making the microprocessor of the controller 12 execute a corresponding program. These programs are memorized in a program memory in the controller 12 or the program memory area of the memory 13. The programs memorized in the program memory or memory area may be prememorized therein by a program writer during manufacture of the terminal, or may be read from an external memory such as a CD-ROM or memory card and written to the program memory or program memory area when the use of the terminal is started, or may be downloaded from a maker site via a communication network and written to the program memory or program memory area.

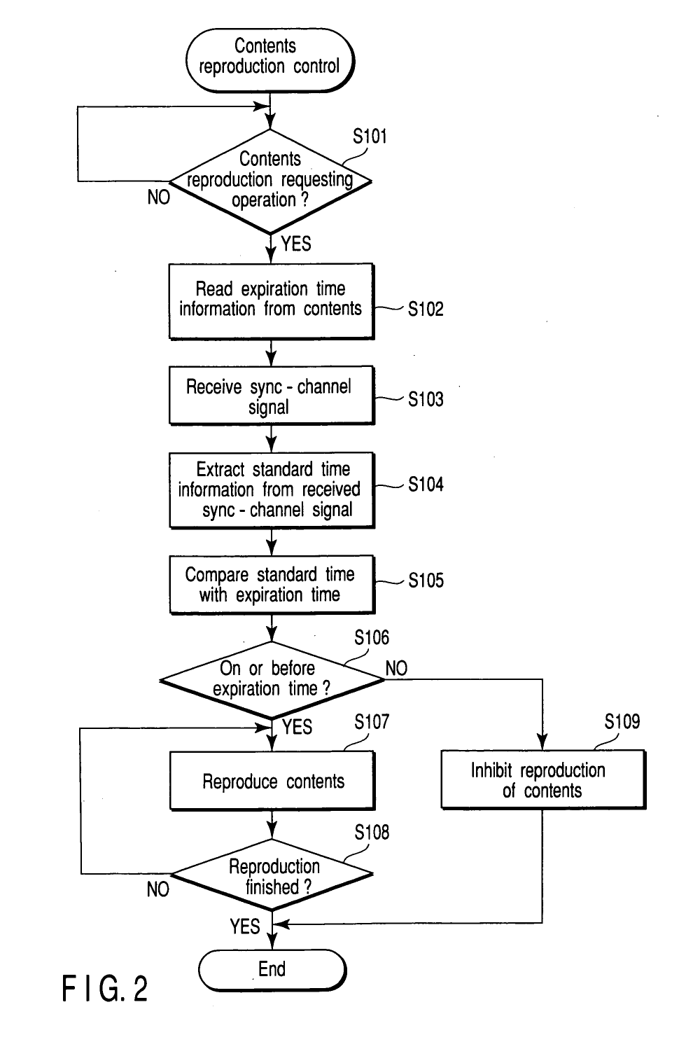

A description will now be given of the contents reproduction operation of the mobile communication terminal constructed as above. FIG. 2 is a flowchart illustrating the procedure of contents reproduction control executed by the controller 12.

The memory 13 prestores contents. The contents are downloaded from, for example, a web site on the Internet, or transferred from an external information device, such as a personal computer, via a cable or radio interface such as Bluetooth, or read from a memory card. The contents are thus received and memorized in the memory 13.

During an idle state, the controller 12 monitors, at a step S101, an operation for reproducing contents executed by a user. In this state, suppose that the user has designated the contents memorized in the memory 13 and has executed the reproduction operation of the contents, using the input unit 14. At this time, firstly, the controller 12 activates the expiration time detecting function 12b, thereby reading, from the memory 13 at a step S102, expiration time information corresponding to the designated contents.

Subsequently, the standard time acquisition control function 12c is activated to acquire system time data (the system time data usually include date information) as standard time data from the base station BS. The acquisition of the system time data is executed by once switching the receiving channel from the paging channel to the sync-channel, then receiving a sync-channel signal from the base station BS at a step S103, and extracting system time data from the received sync-channel signal at a step S104.

After that, at a step S105, the controller 12 compares the extracted system time data with the expiration time information previously read from the memory 13, thereby detecting at a step S106 whether or not the reproduction expiration time of the designated contents has been exceeded.

If the detection result indicates that the reproduction expiration time of the designated contents has not been exceeded, the controller 12 activates the contents reproduction control function 12a, thereby executing reproduction of the designated contents at a step S107. In this reproduction process, for example, the contents are read from the memory 13, and it is detected whether the contents are audio contents such as music, or photo contents such as a still image used as a wallpaper. If they are audio contents, audio data is decoded and output from the speaker 10 via the PCM encoder 8 and receiving signal amplifier 9. On the other hand, if the contents are photo ones, still image data is decoded and displayed on the display unit 15.

Further, if the contents are motion video contents formed of audio data and visual data, the audio data is decoded and then output from the speaker 10 via the PCM encoder 8 and receiving signal amplifier 9. On the other hand, the visual data is decoded and then displayed on the display unit 15. The output operation of the audio data and the display operation of the visual data are executed in synchronism with each other, using the time stamps attached to the data.

If a speaker dedicated to reproduction of audio contents is provided in addition to the speaker 10, audio data is controlled to be output from the speaker dedicated thereto. Further, if output terminals for audio and video data are provided, audio date and video data are supplied to, for example, an external personal computer via the output terminals, where they are output and displayed.

When reproduction of contents has started, the controller 12 monitors at a step S108 whether reproduction has finished, and returns to the idle state after reproduction finishes.

On the other hand, suppose that it is detected at the step S106 that the reproduction expiration time of the designated contents has been exceeded. In this case, the controller 12 executes a reproduction inhibition process on the contents at a step S109, and returns to the idle state.

As described above, in the embodiment, before the reproduction of contents, system time data transmitted from the base station BS via the sync-channel is received, and detection as to the reproduction expiration time of the contents is performed using the received system time data as standard time data. If it is detected that the reproduction expiration time of the contents has not been exceeded, the reproduction of the contents is permitted, whereas if it is detected that the reproduction expiration time of the contents has been exceeded, the reproduction of the contents is inhibited.

Accordingly, contrary to a conventional case where detection as to an expiration time is executed using the time measured by a user clock, detection as to the reproduction expiration time of contents can be executed accurately regardless of an error in the user clock. Further, even when the time of the user clock has been intentionally changed by a user, the influence of the change can be avoided, therefore unauthorized use of contents can be reliably prevented.

The invention is not limited to the above-described embodiment. For example, in the embodiment, system time data is extracted from a sync-channel signal transmitted from the base station BS, and is used as standard time data. However, if the terminal has a GPS receiver 30, the system time data transmitted from a navigational satellite may be received by the GPS receiver and used as standard time data.

Furthermore, although in the embodiment, the contents containing a reproduction expiration time have been described, the invention is also applicable to contents that contain a reproduction valid term.

In addition, in the embodiment, a CDMA mobile communication terminal is used as an example of a mobile communication terminal. However, a mobile communication terminal such as a TDMA (Time Division Multiple Access) mobile communication terminal or analog mobile communication terminal, which employs another radio communication system, may be used. The mobile communication terminal is not limited to mobile phones, but may be, for example, personal data terminals (e.g. PDAs).

Yet further, the structures of the standard time acquisition control function, expiration time detecting function and contents reproduction control function, the control procedures and contents for them, and the types, forms, structures, etc. of contents may be modified in various ways without departing from the scope of the invention.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

Regardless of an error in an internal clock, accurate detection as to a reproduction expiration time can be executed. Further, regardless of a user's intentional change of the measured time, unauthorized use of contents is prevented.

1. A mobile communication terminal including a function for reproduction of contents that contain a reproduction expiration time, comprising:
means for acquiring a standard time from an external device;
means for comparing the standard time, which is acquired by the acquiring means, with the reproduction expiration time of the contents;
means for detecting whether or not the standard time has exceeded the reproduction expiration time of the contents; and
means for enabling reproduction of the contents if the detecting means detects that the standard time has not exceeded the reproduction expiration time of the contents.

2. A mobile communication terminal according to claim 1, wherein if the mobile communication terminal has a radio communication function used to connect the mobile communication terminal to a base station for a mobile communication system which employs a CDMA (Code Division Multiple Access) system, the acquiring means receives system time data, which is transmitted from the base station via a control channel, using the radio communication function.

3. A mobile communication terminal according to claim 1, wherein if the mobile communication terminal has a GPS (Global Positioning System) receiving function, the acquiring means receives system time data, which is transmitted from a navigational satellite, using the GPS receiving function.

4. A mobile communication terminal including a function for reproduction of contents that contain a reproduction expiration time, comprising:
means for acquiring a standard time from an external device;
a comparator which compares the standard time, which is acquired by the acquiring means, with the reproduction expiration time of the contents;
a detector which detects whether or not the standard time has exceeded the reproduction expiration time of the contents; and
a reproduction controller which enables reproduction of the contents if the detector detects that the standard time has not exceeded the reproduction expiration time of the contents.
